(19) United States
(12) Patent Application Publication
(10) Pub. No.: US 2025/0275877 A1
(43) Pub. Date: Sep. 4, 2025

(54) NEONATAL SUPPORT SYSTEM

(71) Applicant: THE REGENTS OF THE UNIVERSITY OF CALIFORNIA, Oakland, CA (US)

(72) Inventor: Mohammad Alnoor, Oakland, CA (US)

(21) Appl. No.: 19/069,472

(22) Filed: Mar. 4, 2025

Related U.S. Application Data
(60) Provisional application No. 63/560,870, filed on Mar. 4, 2024.

(51) Int. Cl. A61G 13/02

(52) U.S. Cl. CPC A61G 13/02; A61G 2200/14

(57) ABSTRACT

A system may include at least one baby support surface. A system may include a support structure configured to mate with the incubator and to support the at least one baby support surface at a support level. A system may include the support structure defining at least one opening adjacent the support level and proximate the at least one baby support surface, the at least one opening configured to be proximate the incubator bed when the support structure is mated with the incubator, the at least one opening sufficiently sized for passage of the baby therethrough, wherein the at least one baby support surface is configured to support the baby at a desired support level for procedures.

### CROSS-REFERENCE TO RELATED APPLICATIONS

This application claims priority U.S. Provisional Patent Application No. 63/560,870, filed on Mar. 4, 2024, the entire contents of which are incorporated herein by reference.

### BACKGROUND

Disclosed herein are supports for neonatal activities and in particular supports for babies during procedures.

### SUMMARY

Accordingly, the present disclosure is directed to a neonatal support that obviates one or more of the problems due to limitations and disadvantages of the related art.

A neonatal support system is disclosed for supporting a baby near an incubator having an incubator bed. The system includes a baby support surface and a support structure. In some aspects, the support structure is configured to mate with the incubator and to support the baby support surface at a support level, such as at a level higher than the incubator bed or at a position spaced adjacent and away from the bed or at a lower level than the incubator bed. The support structure can also define at least one opening adjacent (such as below) the support level and proximate the support surface. For example, the support structure may include one or more legs, such as one, two, three or four legs, and the (for multiple legs) opening can be, for example, the space between a pair of legs. Advantageously, the opening is configured to be proximate the incubator bed when the support structure is mated to the incubator. The opening is sufficiently sized to accommodate the operator moving the baby between the incubator bed and the baby support surface. Also advantageously, the support surface is configured to support the baby at the support level for various procedures, such as X-rays and other fluoroscopy procedures including fitting C-shaped fluoroscopy instruments.

According to one implementation, a neonatal support system is disclosed. The neonatal support system is for supporting a baby near an incubator having an incubator bed. The neonatal support system includes at least one baby support surface and a support structure. The support structure is configured to mate with the incubator and to support the at least one baby support surface at a support level. The support structure defines at least one opening adjacent the support level and proximate the at least one baby support surface. The at least one opening is configured to be proximate the incubator bed when the support structure is mated with the incubator. The at least one opening is sufficiently sized for passage of the baby therethrough, The at least one baby support surface is configured to support the baby at a desired support level for procedures.

In some implementations, the support level is higher than the incubator bed.

In some implementations, the support structure includes at least one leg and wherein the at least one leg is configured to fit into an existing opening defined in the incubator.

In some implementations, the at least one leg includes two legs and the at least one opening is defined between the two legs.

In some implementations, the two legs are telescoping to adjust the support level.

In some implementations, the support structure is configured to adjust the support level.

In some implementations, the at least one baby support surface is at least partially radiopaque.

In some implementations, the at least one baby support surface includes at least one blocking surface configured to contain the baby when supported on the at least one baby support surface.

In some implementations, the at least one blocking surface includes a pair of blocking surfaces positioned opposite each other.

In some implementations, the pair of blocking surfaces are configured to move toward and away from each other to hold the baby therebetween.

In some implementations, the at least one baby support surface is part of a table and wherein each of the blocking surfaces is associated with one of a pair of side rails.

In some implementations, the pair of side rails are configured to slide toward and away from each other along the at least one baby support surface of the table.

In some implementations, the neonatal support system further includes a top rail and a bottom rail spaced apart from each other across the pair of side rails.

In some implementations, the table defines a pair of slots configured to guide sliding of the side rails.

In some implementations, the neonatal support system further includes posts extending from the side rails into the slots and configured to slide therealong.

In some implementations, the side rails define belt openings configured for passage of a belt to restrain the baby on the at least one baby support surface.

In some implementations, the support structure includes a plurality of legs and wherein each of the plurality of legs is configured for adjustable length.

In some implementations, each of the plurality of legs attaches to an underside of the table.

In some implementations, each of the plurality of legs is pivotably mounted to the table and are configured to pivot into folded positions and the plurality of legs extend along the underside of the table in the folded positions.

In some implementations, the posts are configured to clamp the table there between.

In some implementations, the table is configured to rotate about a vertical axis with respect to the support structure.

In some implementations, the at least one opening is sufficiently sized to receive a component of a diagnostic machine.

In some implementations, the diagnostic machine is an x-ray machine.

According to another implementation, a method of supporting a baby is disclosed. The method includes mating a support structure to an existing incubator bed. The method further includes supporting a baby support surface at a support level different than an incubator bed with the support structure. The method further includes defining at least one opening in the support structure below the support level and proximate the baby support surface. The method further includes obtaining the baby from the incubator bed and placing the baby on the baby support surface. The method further includes performing a procedure on the baby on the baby support surface.

In some implementations, the method further includes inserting a portion of a diagnostic device in the at least one opening below the baby before performing the procedure and wherein performing the procedure includes using the diagnostic device.

According to another implementation, an incubator for incubating a baby is disclosed. The incubator includes a base having a top surface, an incubator bed including at least one support surface configured to support the baby, and a support structure extending from the top surface and supporting the incubator bed so that the at least one support surface is at a support level. The support structure is adjustable to define at least one opening between the incubator bed and the top surface. The at least one opening is sufficiently sized to facilitate medical procedures. The at least one support surface is configured to support the baby at a desired support level.

In some implementations, the support structure includes adjustable legs and wherein each of the adjustable legs has an adjustable length for selectively changing the support level and an orientation of the incubator bed.

In some implementations, at least one opening is configured to receive an x-ray machine.

Advantages include the system being light weight and easy to transport; allowing for the placement in different sizes of cribs, beds and tables; it can be radiolucent for x-ray imaging; the baby support surface may be rotatable to allow patient access and raised edges/straps can secure the patient. Further embodiments, features, and advantages of the neonatal support are described in detail below with reference to the accompanying drawings.

It is to be understood that both the foregoing general description and the following detailed description are exemplary and explanatory only and are not restrictive of the invention as claimed.

### BRIEF DESCRIPTION OF THE DRAWINGS

The accompanying figures, which are incorporated herein and form part of the specification, illustrate a neonatal support system. Together with the description, the figures further serve to explain the principles of the neonatal support system described herein and thereby enable a person skilled in the pertinent art to make and use the intravascular stent.

FIG. 1 shows a schematic (perspective view) of a neonatal support system, according to one implementation.

FIG. 2 shows a schematic of the neonatal support system of FIG. 1 having its height adjusted with adjustable legs.

FIG. 3 shows a schematic of the neonatal support system of FIG. 1 having a support table rotated about a vertical axis.

FIG. 4 shows a schematic of the neonatal support system of FIG. 1 including a strap to secure a baby.

FIG. 5 shows a schematic of the neonatal support system of FIG. 1 adjusted to support the baby at an angle or raise the level of the baby.

FIG. 6A shows a schematic of another neonatal support system mated with an existing incubator system and adjacent an x-ray machine, according to one implementation.

FIG. 6B shows a neonatal support system configured for use with the x-ray implementation of FIG. 6A.

FIG. 7 shows a bottom of another neonatal support system including a pair of adjustable side rails, according to one implementation.

FIG. 8 shows a perspective view the neonatal support system of FIG. 7 with adjustable leg height to allow angulation of the surface.

FIG. 9 shows an enlarged perspective view of a leg of the neonatal support system of FIG. 7.

FIG. 10 shows a perspective view of the neonatal support system of FIG. 7 with the side rails positioned inwardly towards each other.

FIG. 11 shows a perspective view of another neonatal support system, according to one implementation.

FIG. 12 is a side elevation view of a neonatal support system built into an incubator system including a bed having an adjustable level and orientation, according to one implementation.

FIG. 13 is a side elevation view of the incubator system of FIG. 12 wherein legs of the support system are extended to raise the bed and provide room for a procedure such as insertion of an x-ray machine.

FIG. 14 is a perspective view of another embodiment of an incubator system with a built in neonatal support system and including an incubator shell covering the bed, according to one implementation.

FIG. 15 is a perspective view of the incubator system of FIG. 14 with the bed raised to facilitate a medical procedure.

FIG. 16 is a perspective view of the incubator system of FIG. 15 with the lid portion removed.

### DETAILED DESCRIPTION

Although the systems, methods, and devices of the present disclosure have been disclosed in the context of certain preferred embodiments and examples, it will be understood by those skilled in the art that the present disclosure extends beyond the specifically disclosed embodiments to other alternative embodiments and/or uses of the systems and methods herein and obvious modifications and equivalents thereof. In addition, while several variations of the systems, methods, and devices have been shown and described in detail, other modifications, which are within the scope of this disclosure, will be readily apparent to those of skill in the art based upon this disclosure.

It is also contemplated that various combinations or sub-combinations of the specific features and aspects of the embodiments may be made and still fall within the scope of the invention. Accordingly, various features and aspects of the disclosed embodiments can be combined with or substituted for one another to form varying modes of the disclosed invention. Thus, it is intended that the scope of the present disclosure herein disclosed should not be limited by the disclosed embodiments described above but should be determined only by a fair reading of the claims that follow.

Similarly, this method of disclosure is not to be interpreted as reflecting an intention that any claim requires more features than are expressly recited in that claim. Rather, as the following claims reflect, disclosed aspects lie in a combination of fewer than all features of any single foregoing disclosed embodiment. Thus, the claims following the Detailed Description are hereby expressly incorporated into this Detailed Description, with each claim standing on its own as a separate embodiment.

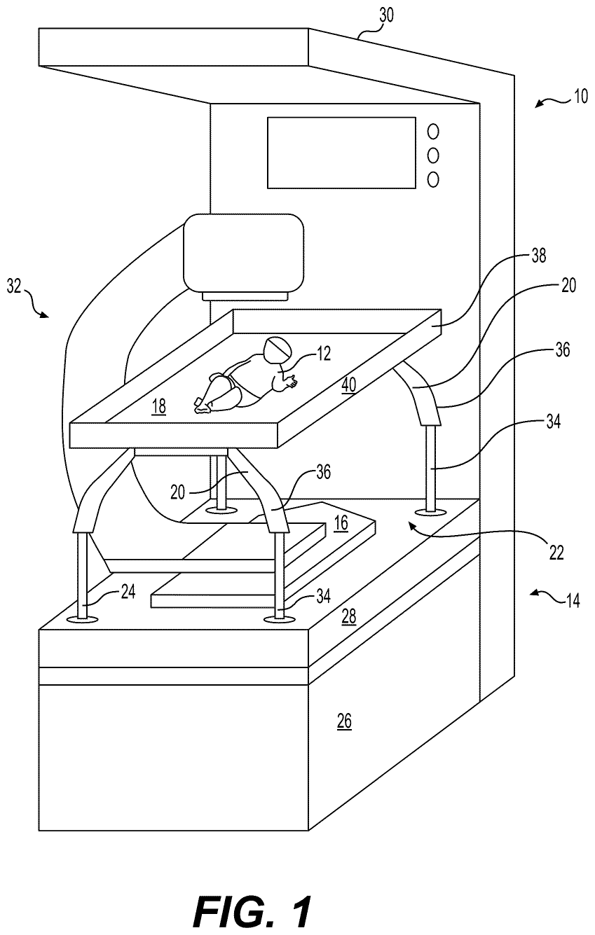

As shown in FIG. 1, a neonatal support system 10 is disclosed for supporting a baby 12 near an incubator 14 having an incubator bed 16. The system 10 includes a baby support surface 18 and a support structure 20. In some aspects, the support structure 20 is configured to mate with the incubator 14 and to support the support surface 18 at a support level, such as at a level higher than the incubator bed 16.

The support structure 20 can also define at least one opening 22 below the support level and proximate the baby support surface 18. For example, the support structure 20 may include a plurality of legs 24 and the opening 22 is the space between a pair of legs. Advantageously, the opening 22 is configured to be proximate the incubator bed 16 when the support structure 20 is mated to the incubator 14. The opening 22 is sufficiently sized to accommodate the operator moving the baby between the incubator bed 16 and the baby support surface 18. Also advantageously, the support surface 18 is configured to support the baby 12 at the support level for various procedures, such as X-rays.

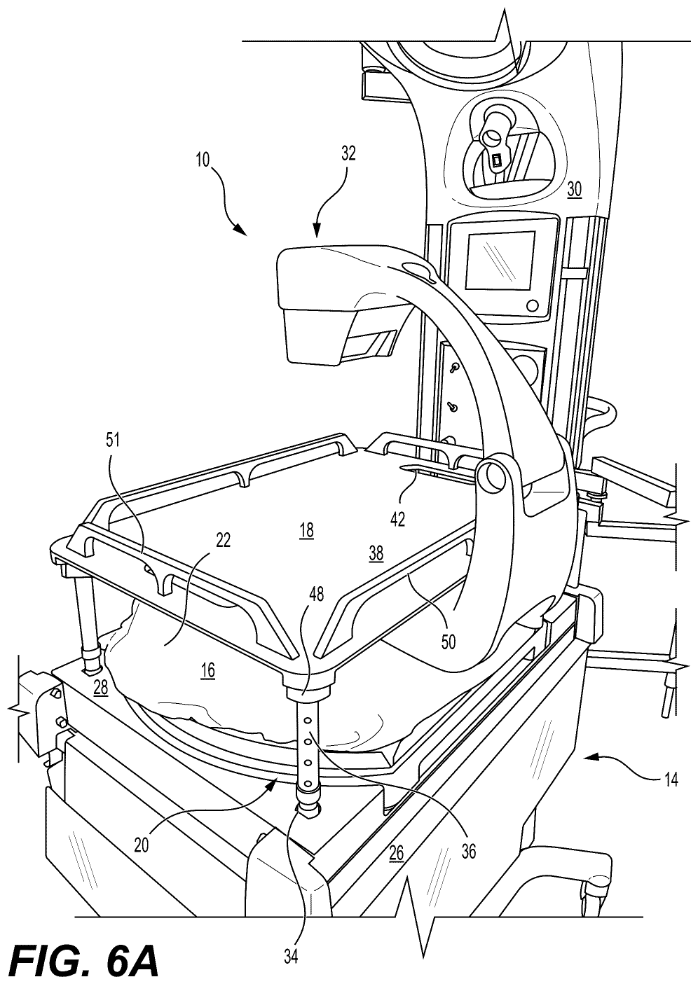

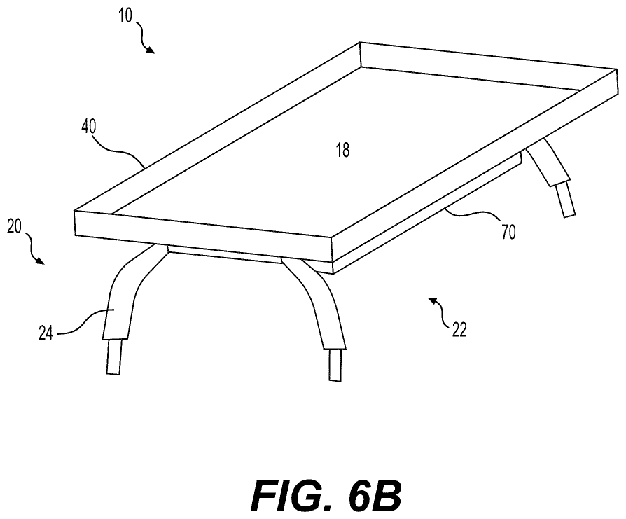

Referring to FIG. 1 again, the incubator 14 (shown schematically) generally is a specialized container for premature babies and includes a base 26, a top 28 and the bed 16. The base for example can be a roughly rectangular structure that stably supports the top 28. The top 28 in turn supports the incubator bed 16. The incubator 14 can also include a gantry 30 that is cantilevered over the incubator bed 16. The gantry 30 can house various monitoring instruments, lighting and/or a top or cover that can be lowered over the incubator bed 16 (as shown for example in FIG. 6A). The base 26 may include wheels for mobilizing the incubator 14 for movement within a hospital or other care facility.

Despite the mobility of the incubator 14, wheeling the infant around the care facility including on and off elevators can be very burdensome. It was observed that finding a way to do procedures without moving the baby would yield safety, staffing, and cost advantages. In addition, moving premature babies between various equipment poses additional stress for the babies. The designed neonatal support system addresses these concerns and achieve other advantages.

The term “incubator” as used herein refers to any piece of equipment meant to care for small life forms and which would benefit from the establishment of additional surfaces for performing additional or different procedures and conveniently returning the life form to its original position.

The neonatal support system 10 may also be used in conjunction with other equipment such as a scanning system or a radiographic or x-ray system 32 as shown in FIG. 6A. The x-ray system 32 has its own base and gantry, the gantry supporting a transmitter and/or receiver to generate digital x-rays of the baby 12. Advantageously, the neonatal support system—as will be described more below-provides space for insertion of the base of the x-ray system 32 below the baby and the gantry above the baby all on top of the incubator 14. For example, FIG. 6B shows a lower space 70 defined underneath the support surface 18 within the opening 22. The lower space 70 is configured to retain, engage with, and/or couple to a base portion of the x-ray system 32. This is just one example of how additional equipment can be combined with the neonatal support system 10 to improve patient treatment.

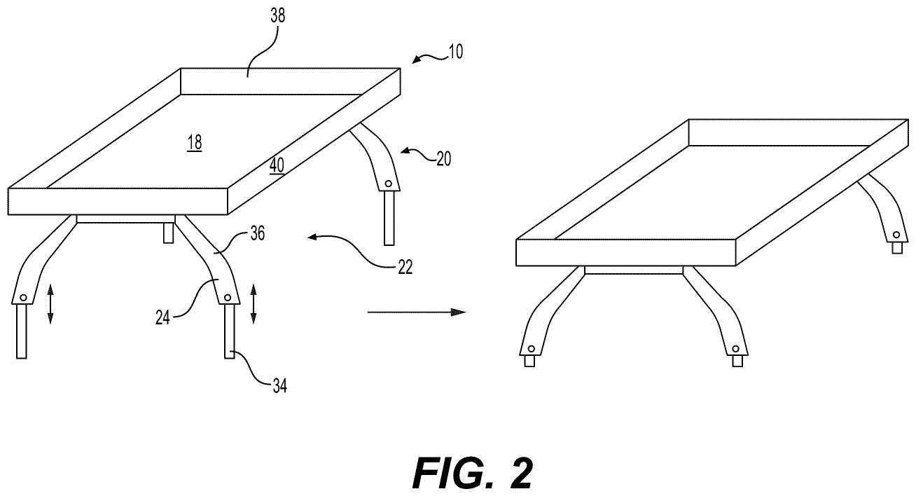

The support structure 20 of the neonatal support system 10 is any structure that can stably support the baby support surface 18 adjacent to or in proximity to the incubator 14 and/or incubator bed 16. The support structure may be regular shape, such as a box-like structure, or may be formed of irregular shapes. As shown in FIGS. 1-5, the support structure 20 may include one or more legs, in this instance the four legs 24. As shown in FIG. 2, the legs 24 may have a foot component 34 and an upper component 36. The upper component 36 has an elongate curved shape with a first, top end connected to the underside of a baby support tray 38 which includes the baby support surface 18. First ends of a pair of the upper components 36 may also be interconnected with each other for additional stability.

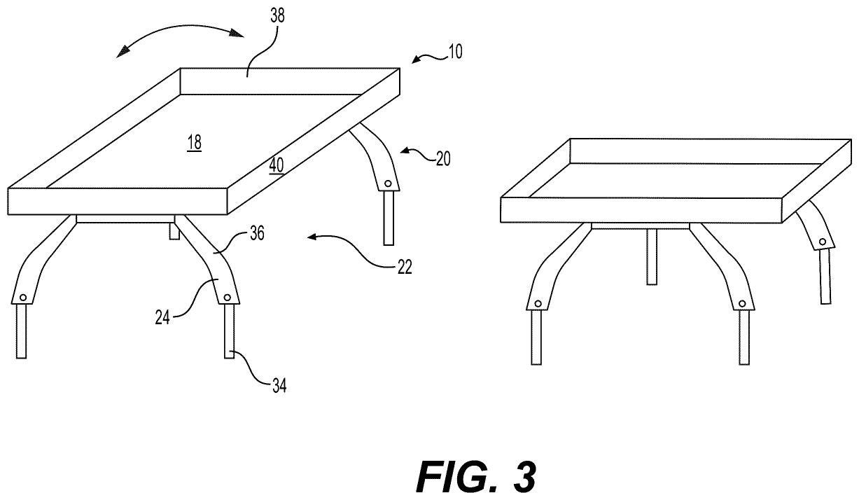

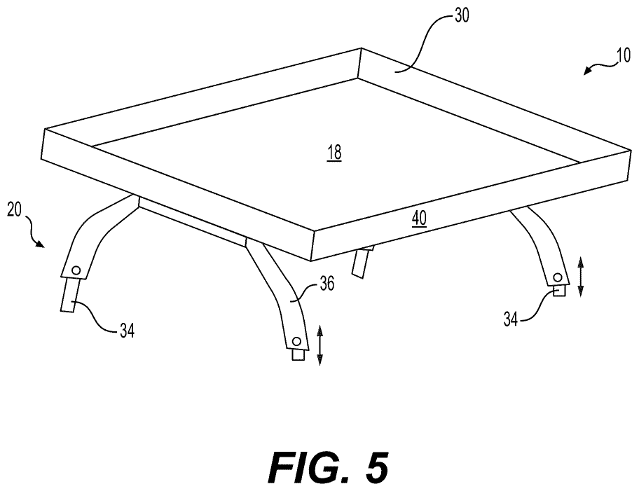

The upper components 36 preferably define openings on a second, bottom end that is configured to receive an upper portion of the foot component 34. The foot component may therefore telescope in and out of the respective opening for adjustable length of assembly and in turn adjustable angle and height of the support structure 20 and baby support surface 18. In this way, a baby support level can be adjusted and/or manipulated in height and orientation, as shown in FIG. 2. FIG. 5, for example, shows a pair of the legs 24 selectively adjusted to adjust the angle of the baby support tray 38. FIG. 3 also shows the baby support tray 38 being rotated on its vertical axis for additional flexibility of baby positioning. Other structures can be employed to adjust the height and angle of the baby support tray 38, such as via a multi-linkage support motivated by servos or via a ball joint that allows multiple angle articulation.

In some aspects, the bottom ends of the of foot components 34 can have rubbery or non-slip surface and can be sized and shaped to fit into existing openings in the top 28 or other portion of the incubator 14, as shown in FIG. 1. In this manner, the support structure can be configured to “mate” with the incubator. The support structure can employ other electronic or mechanical or chemical ways of coupling with securely—or mating with—the incubator. For example, magnets, clamps or screws or other fasteners could be employed or adhesives, if the mating is relatively secure for the purposes of supporting the baby support surface 18 in a stable configuration.

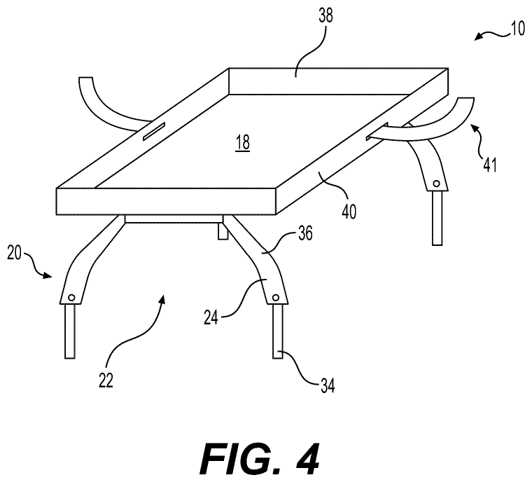

As shown in FIGS. 1 and 4, the baby support surface 18 may be a top surface of the baby support tray 38. The baby support tray for example can have a planar bottom and then a wall structure 40 extending therearound-such as in a rectangular shape—that is sized to fit the baby and provide some additional security against movement of the baby off of the baby support surface 18. In FIG. 4, the wall structure is relatively short but also defines side openings or slots that are configured to receive a belt structure 41. The belt structure 41 wraps up and over the baby 12 on the baby support surface 18 to further help secure the baby during procedures.

The baby support surface 18 can be any surface which is configured to receive and support the baby 12. For example, the baby support surface may be the top surface of a mattress sitting on the top surface of the baby support tray 38. The baby support surface 18 need not be a regular or flat surface but could be shaped and contoured to help position or retain the baby depending on the procedure. The baby support tray 38 may also have special material compositions adapted to work within the expected additional procedures such as being antimicrobial or radiopaque (such as for use of the x-ray system 32).

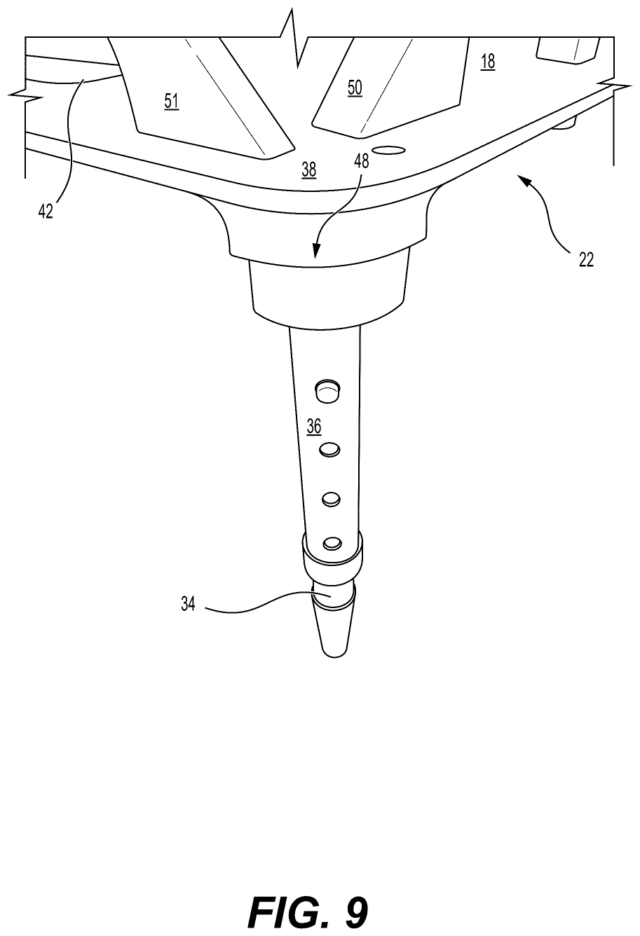

FIGS. 6-10 show another neonatal support system 10. As shown in FIG. 9, each leg includes the relatively sliding foot component 36 and upper component 36. The upper component 36 defines a plurality of openings for discretized adjustments of the relative length of the legs which lock into place due to a spring biased peg. In this manner the legs do not collapse easily back to shorter configurations. The foot component 36 includes a frustoconical shape for fitting into openings defines at four rectangular corners on the incubator 14, as shown in FIG. 6A. Also, the upper component 36 is received in one of four leg mounts 48 positioned on the corners of the baby support tray 38.

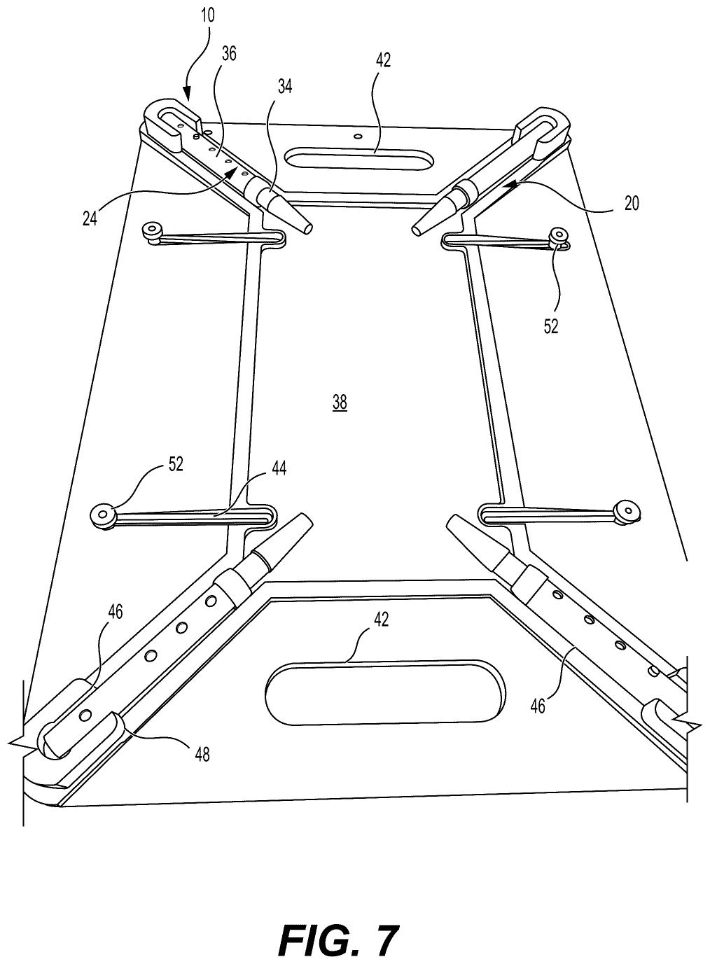

FIG. 7 shows an underside of the baby support tray 38 and includes a pair of handle openings 42 aligned with the short sides of the rectangular-shaped support tray 38. These allow for manual grasping and carrying of the neonatal support system 10. Also defined in the baby support tray 38 are a set of four fastener slots 44 and four leg receptacles 46. The leg receptacles 46 allow for compact folding and storage of the legs 24.

The fastener slots 44 are spaced in pairs and extend perpendicular to the long edges of the rectangular shaped tray 38. Each pair is aligned with the other pair and the slots extend about ¼ to ⅓ of the width of the tray 38. The slots 44 have defined therearound ramps that are configured to progressively tighten against the heads of the fasteners or posts 52 sliding therein as they are urged into the middle of the tray 38.

The leg receptacles 46 are angled at between 30-60 degrees and about 45 degrees relative to the sides of the tray 38. Each of the receptacles 46 has a rounded or semicircular shape that is configured to receive the tubular-shaped legs 24 therein for a thinner profile for the system 10 and easier transportability. Nestled in each of the leg receptacles 46 is a respective one of four leg mounts 48. Each of the leg mounts has a U-shaped configuration that receives the top ends of the legs (upper components 36). The upper components 36 and the leg mounts 48 are each transfixed by a pin so that the legs are pivotable with respect to the leg mounts and the baby support tray 38.

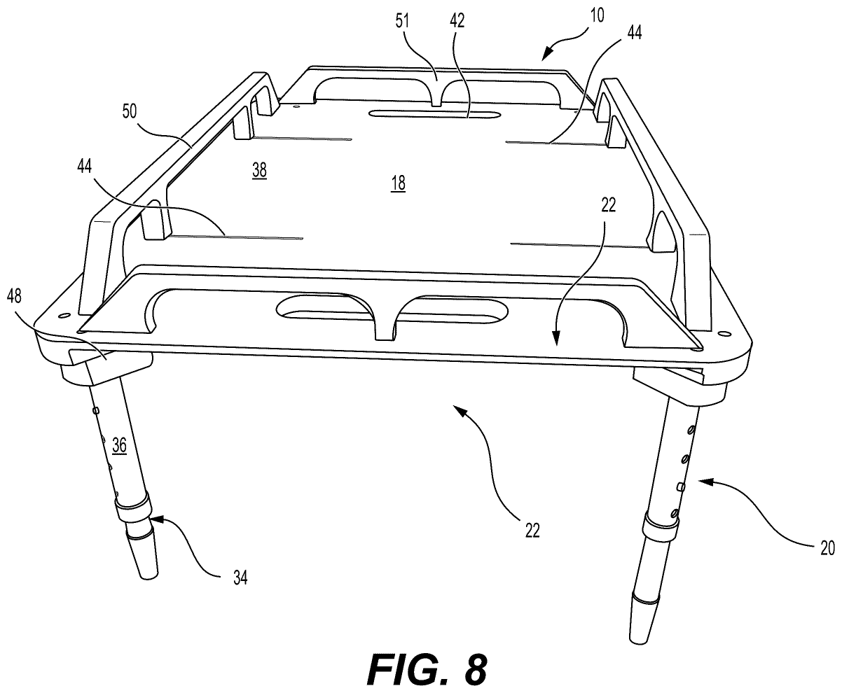

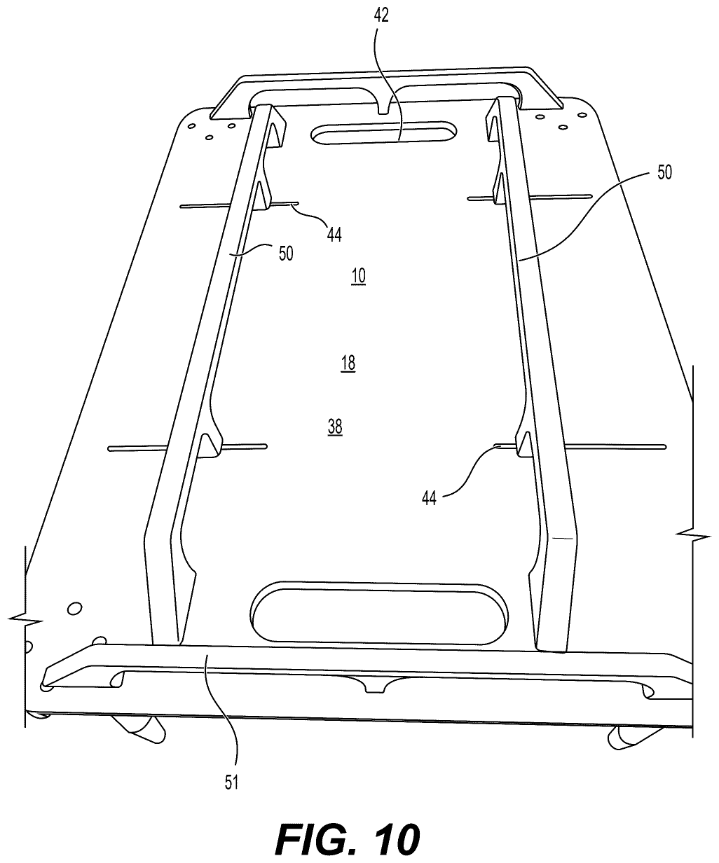

As shown in FIGS. 8 and 10, the baby support tray 38 includes two matched, opposing pairs of side rails 50 and top rails 51. Two of the side rails extend along the short edges of the rectangular shaped support tray 38 and the other two, longer side rails extend along the long edges. Advantageously, the long side rails 50 slide via posts 52 that extend through the pairs of fastener support slots 44. And heads on the posts tighten up as the long rails are adjusted inwards towards each other (FIG. 10)—by riding up the ramps shaped around the fastener support slots 44, shown in FIG. 7. In this manner, the long rails can become more tightly locked into place as they approach the baby positioned in the middle of the baby support surface 18.

It should be noted that although side rails 50 and top rails 51 are illustrated herein, there are other ways to fashion blocking surfaces that facilitate securing the baby, such as the wall structure 40. The illustrated side rails 50 each include four columns, two end columns and two middle columns. The end columns provide additional “outrigger” style stabilization, and the middle columns define openings that are configured to receive the posts receive the posts 52 passed through the fastener support slots 44. Both the side rails 50 and the top rails 51 define openings that allow for easy manual gripping and lesser weight of the system 10.

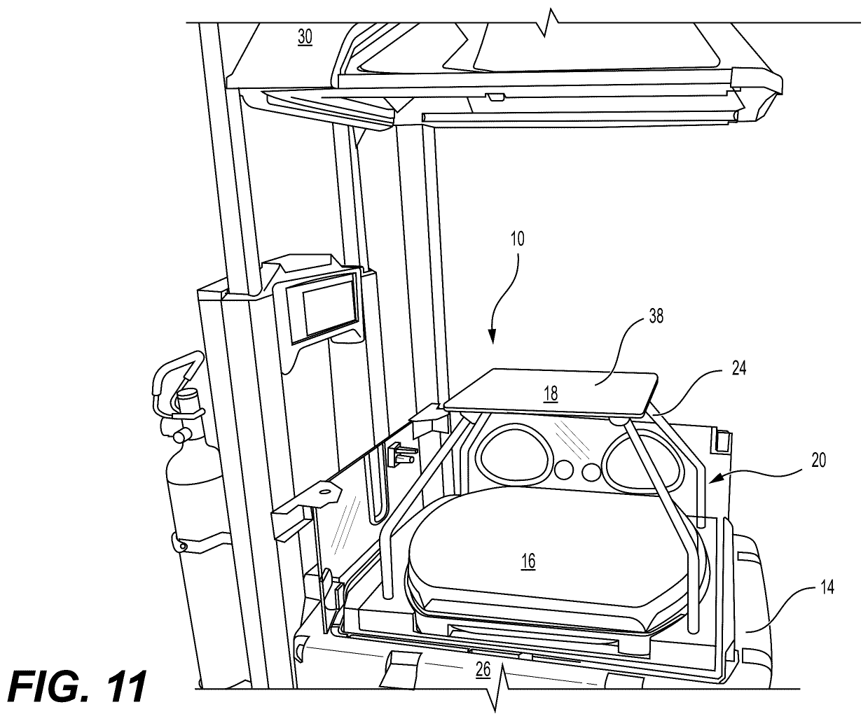

FIG. 11 shows an additional neonatal support system 10. The baby support surface 18 is a flat planar surface with no blocking structure and the legs 24 are elongated metal tubes having bends about ⅓ of the way from their ends. The ends of the legs 24 fit into openings defined in the top 28 of the incubator 14. The opening 22 can the space between any pair of the legs 24.

In other embodiments, the baby support surface 18 may have adjustable widths to accommodate different sized patients-even adult patients. And a range of attachments for safety straps may be used with the neonatal support system 10.

It should be noted also that the baby support surface 18 may be attached to the incubator 14 using a range of attachments not necessarily limited to fitting legs into holes. Clips, clamps, magnets, adhesives, straps, etc. are within the scope of the present invention(s). Also, the ends of the legs such as the foot components 36 may comprise stick rubber for stability and may be shaped to be wedged into other cribs and devices for holding babies.

In yet another embodiment, the system 10 may be expanded to adult usage such as with adult care systems that require movement of the adult to other support surfaces. The system 10 would be adapted in scale to accommodate the larger and heavier patient.

An advantage of the system 10 is its adjustable height allows lowering when not needed, and raising to accommodate other devices or access as needed.

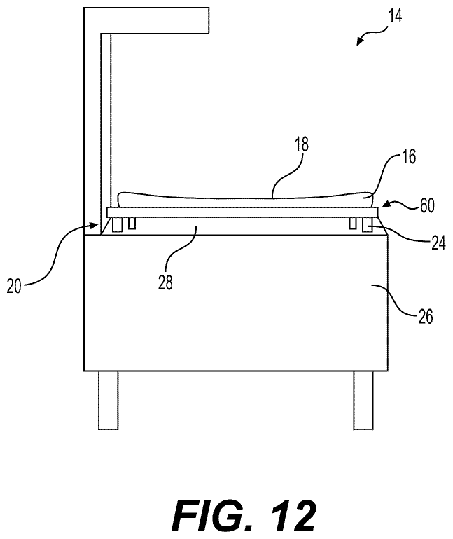

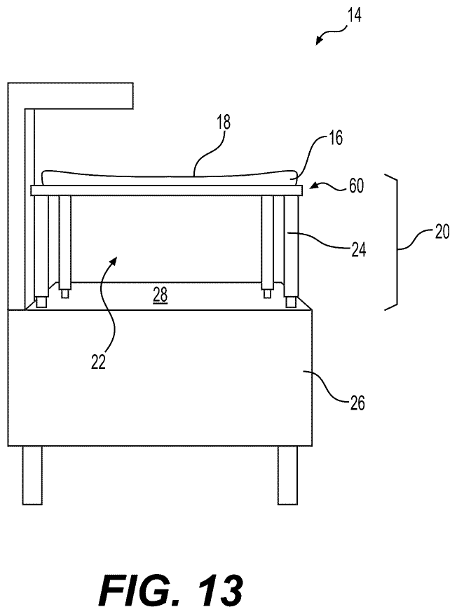

In other embodiments, the incubator 14 may be modified so that the bed 16 is adjustable and thus serves as the support surface 18. The bed, as shown in FIG. 12, includes a table 60 built into the top 28. In the configuration of FIG. 12, the bed 16 includes legs 24 in a retracted state so that the incubator 14 operates similar to other incubators. However, as shown in FIG. 13, the legs 24 of the incubator bed 16 can be extended so as to form the opening 22. As with the prior embodiments, the opening 22 provides access for other equipment such as the x-ray system 32. Of course, the opening 22 may afford access for other equipment or the elevation of the bed 16 may just provide easier access to the infant by health professionals. The bed 16, upon elevation, provides the elevated support surface 18.

Notably, all of the functionality of the legs 24 and table 60, or other support structure 20 such as a linkage assembly or a ball joint or combinations therefore, is still possible when integrated in the incubator 14. For example, the bed 16 may be adjustable in its angle (such as in FIG. 8) and orientation (such as in FIG. 3) by articulating the legs 24 or adjusting other types of support structure capable of translation and/or rotation.

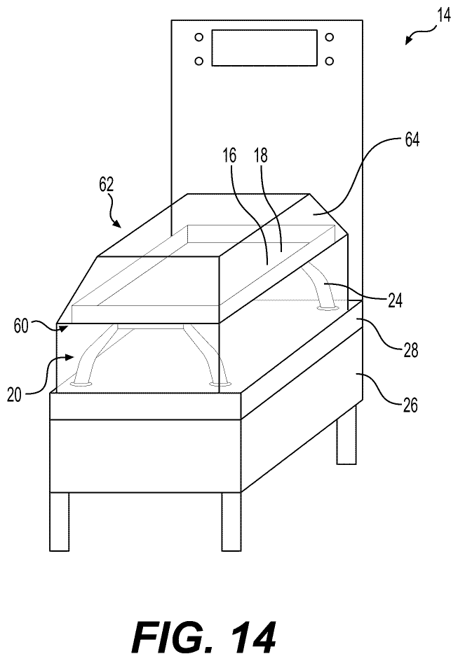

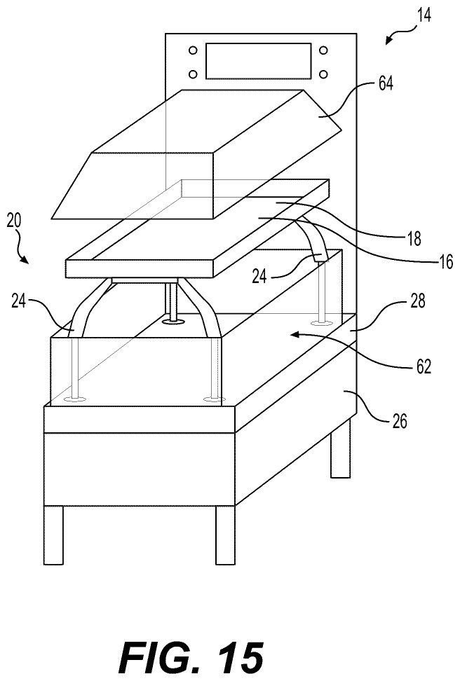

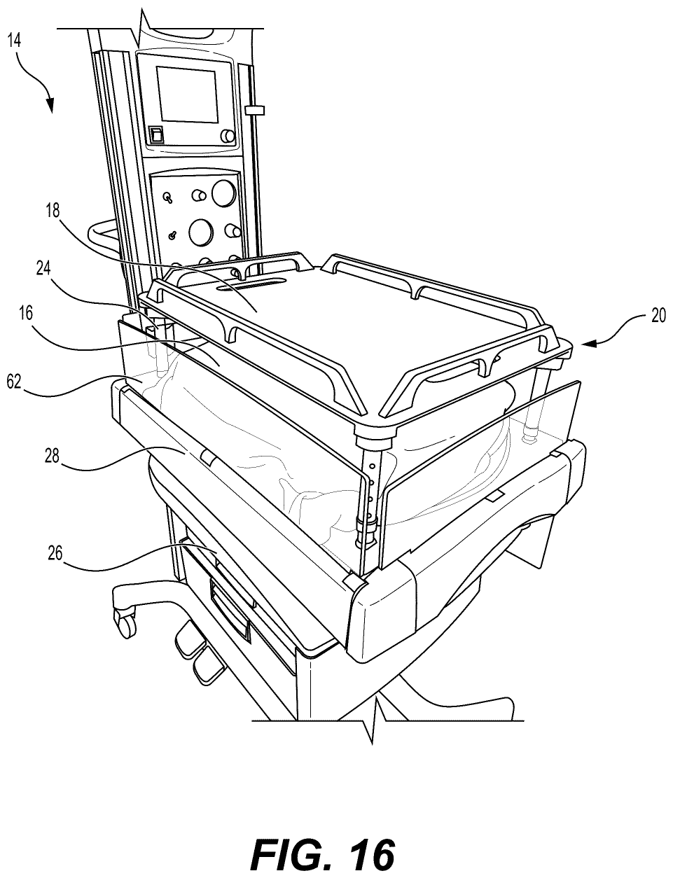

As shown in FIG. 14, a shell 62 can be configured to envelope the built-in table 60 for day-to-day use. In this manner, the incubator 14 may be operated with normal incubation functions but with the added flexibility of adjusting the level and orientation of the bed 16. FIG. 15 shows how a lid portion 64 of the shell 62 can be removed and the table 60 can be articulated to adjust the level and orientation of the bed 16. For example, the legs 24 can be telescoped to adjust the height and orientation of the bed 16 supported thereby. FIG. 16 shows another implementation of the table 60 of FIG. 15 with the lid portion 64 of the shell removed from the shell 62.

While various embodiments of the present disclosure have been described above, they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents.

1. A neonatal support system for supporting a baby near an incubator having an incubator bed, the neonatal support system comprising:
at least one baby support surface;
a support structure configured to mate with the incubator and to support the at least one baby support surface at a support level;
the support structure defining at least one opening adjacent the support level and proximate the at least one baby support surface, the at least one opening configured to be proximate the incubator bed when the support structure is mated with the incubator, the at least one opening sufficiently sized for passage of the baby therethrough;
wherein the at least one baby support surface is configured to support the baby at a desired support level for procedures.

2. The neonatal support system of claim 1, wherein the support level is higher than the incubator bed.

3. The neonatal support system of claim 2, wherein the support structure includes at least one leg and wherein the at least one leg is configured to fit into an existing opening defined in the incubator.

4. The neonatal support system of claim 3, wherein the at least one leg includes two legs and the at least one opening is defined between the two legs, wherein the two legs are telescoping to adjust the support level.

5. (canceled)

6. The neonatal support system of claim 1, wherein the support structure is configured to adjust the support level.

7. The neonatal support system of claim 1, wherein the at least one baby support surface is at least partially radiopaque.

8. The neonatal support system of claim 1, wherein the at least one baby support surface includes at least one blocking surface configured to contain the baby when supported on the at least one baby support surface, wherein the at least one blocking surface includes a pair of blocking surfaces positioned opposite each other.

9. (canceled)

10. The neonatal support system of claim 8, wherein the pair of blocking surfaces are configured to move toward and away from each other to hold the baby therebetween.

11. The neonatal support system of claim 10, wherein the at least one baby support surface is part of a table and wherein each of the blocking surfaces is associated with one of a pair of side rails.

12. The neonatal support system of claim 11, wherein the pair of side rails are configured to slide toward and away from each other along the at least one baby support surface of the table.

13. The neonatal support system of claim 12, further comprising a top rail and a bottom rail spaced apart from each other across the pair of side rails.

14. The neonatal support system of claim 13, wherein the table defines a pair of slots configured to guide sliding of the side rails, the system further comprising posts extending from the side rails into the slots and configured to slide therealong.

15. (canceled)

16. The neonatal support system of claim 11, wherein the side rails define belt openings configured for passage of a belt to restrain the baby on the at least one baby support surface.

17. The neonatal support system of claim 11, wherein the support structure includes a plurality of legs and wherein each of the plurality of legs is configured for adjustable length, wherein each of the plurality of legs attaches to an underside of the table.

18. (canceled)

19. The neonatal support system of claim 17, wherein each of the plurality of legs is pivotably mounted to the table and are configured to pivot into folded positions and wherein the plurality of legs extend along the underside of the table in the folded positions.

20. The neonatal support system of claim 14, wherein the posts are configured to clamp the table there between.

21. The neonatal support system of claim 11, wherein the table is configured to rotate about a vertical axis with respect to the support structure.

22. The neonatal support system of claim 1, wherein the at least one opening is sufficiently sized to receive a component of a diagnostic machine.

23. (canceled)

24. (canceled)

25. (canceled)

26. An incubator for incubating a baby, the incubator comprising:
a base having a top surface;
an incubator bed including at least one support surface configured to support the baby;
a support structure extending from the top surface and supporting the incubator bed so that the at least one support surface is at a support level;
the support structure being adjustable to define at least one opening between the incubator bed and the top surface, the at least one opening sufficiently sized to facilitate medical procedures;
wherein the at least one support surface is configured to support the baby at a desired support level.

27. The incubator of claim 26, wherein the support structure includes adjustable legs and wherein each of the adjustable legs has an adjustable length for selectively changing the support level and an orientation of the incubator bed.

28. The incubator of claim 27, wherein at least one opening is configured to receive an x-ray machine.
